(19) United States
(12) Patent Application Publication
(10) Pub. No.: US 2016/0256030 A1
(43) Pub. Date: Sep. 8, 2016

(54) Cleaning Implement with Resilient Projections

(71) Applicant: The Libman Company, Arcola, IL (US)

(72) Inventors: Aaron Libman, Champaign, IL (US); Andrew D. Libman, Champaign, IL (US); Roberto Pellacini, Torrechiara Langhirano (IT)

(73) Assignee: The Libman Company, Arcola, IL (US)

(21) Appl. No.: 15/062,771

(22) Filed: Mar. 7, 2016

Related U.S. Application Data
(63) Continuation-in-part of application No. 29/519,774, filed on Mar. 6, 2015.
(60) Provisional application No. 62/129,583, filed on Mar. 6, 2015.

(51) Int. Cl. A47L 13/256; B25G 3/36; B25G 1/06

(52) U.S. Cl. CPC A47L 13/256; B25G 1/06; B25G 3/36

(57) ABSTRACT

A cleaning apparatus such as a bath scrubber with an undulation feature is disclosed. The cleaning apparatus may have a base that is pivotally coupled to a handle. The base may include multiple projections (e.g., flanges) that together form a substantially X-shape. Each projection may include a resilient section that may deflect when in contact with a curved surface to enable a cleaning pad coupled to the projections to clean the curved surface. The resilient section may comprise one or more undulations features.

### RELATED APPLICATIONS

The present application is a non-provisional application of U.S. Provisional Application No. 62/129,583, filed Mar. 6, 2015. The content of this application is incorporated herein by reference in its entirety for all purposes, and this application claims priority to the Provisional Application, as well as U.S. Design Pat. Application No. 29/519,774, filed on Mar. 6, 2015, which is also incorporated herein by reference in its entirety for all purposes.

### TECHNICAL FIELD

The disclosure herein relates to the field of cleaning implements, and more specifically to the field of bath scrubbers comprising an undulating or flexible region. Aspects of the disclosure relate to maintaining pressure on a cleaning pad of the bath scrubber when the pad is in contact with a curved surface of e.g., a bathtub.

### BACKGROUND

Various bath scrubbers, mops and other cleaning appliances have been used to clean floors and other surfaces. However, the bathtub, toilet and other areas of a bathroom present unique obstacles that make cleaning them both time consuming and difficult for a user since they include many small and hard-to-reach areas that traditional scrubbers cannot reach and clean efficiently. As an example, a bathtub includes many curved surfaces, such as, for example, at the exterior and interior base of the bathtub. Many mops have a rigid base that does not permit flexing which is coupled to a cleaning pad. As a result, the cleaning pads of such mops are not permitted to flex and/or otherwise bend to conform to the curved surface, making cleaning of the curved service more difficult and time-consuming. Further, by virtue of the cleaning pad's rigid planar shape, the cleaning pad cannot contact substantial portions of the curved surface at the same time.

Accordingly, there is an ever-present need for cleaning implements that enable a user to more quickly and efficiently clean curved surfaces of a bathroom.

### BRIEF SUMMARY

The present disclosure contemplates a cleaning implement that enables its cleaning pad to flex to conform to a curved surface while maintaining pressure on the cleaning pad using an undulation feature thereby enabling the cleaning pad to maintain contact with the curved surface for efficient cleaning thereof. The following presents a simplified summary of the disclosure in order to provide a basic understanding of some aspects. It is not intended to identify key or critical elements or to delineate the scope of the disclosure. The following summary merely presents some concepts of the disclosure in a simplified form as a prelude to the more detailed description provided below.

In one aspect of the disclosure, a cleaning implement is provided, which may be in the form of, for example, a bath scrubber. In some examples, the cleaning implement comprises a base and a cleaning pad. In certain embodiments the base comprises a bottom surface having a first height, at least one top surface, and at least one side exterior surface. In some examples, the base comprises a recess in the at least one top surface and at least one connection component contained within the recess, the at least one connection component being pivotally connected to the base. In various examples, the base includes at least two projections attached to the base at a second height and extending out from the side exterior surface.

Each projection may include a first end, a second end, and an intermediate portion between the first and second end. In various embodiments, the first end is attached to the side exterior surface of the base (at the second height), the second end is attached to a portion of the cleaning pad, and the intermediate portion comprises at least one resilient portion. In certain examples, the resilient portion of each projection allows the second end to deflect from a first projection height (which may be equal to the first height of the base, or may be a different height) to at least a second projection height, while the second projection end remains at a constant height by virtue of its attachment to the base.

In various embodiments, the resilient portion of each projection comprises an undulating surface. In some examples, the resilient portion of each projection comprises at least one concave region and at least one convex region. In certain embodiments, the resilient portion of each projection comprises a pair of concave regions separated by a convex region. In various examples, the resilient portion of each projection comprises a flat surface connected to the second end, a first concave surface connected to the flat surface, a first convex surface connected to the first concave surface, a second concave surface connected to the first convex surface, and a second convex surface connected to the second concave surface, the second convex surface connected to the exterior side surface of the base. In various examples, one or more curved (e.g. concave) sections or undulating sections resiliently flex when the second end is deflected, for example when the cleaning implement is in contact with a curved surface to be cleaned. In this representative example, a curved surface to be cleaned deflects the second end upward and the projection, by virtue of the resilient flexing, imposes a downward force along at least a section of the intermediate portion (and, in certain examples, all of it) and/or a distal portion of the projection. In some examples, the cleaning pad has a perimeter, where the second end of each projection is attached to the cleaning pad on or near an edge of the perimeter (for example, by one of more hook structures).

### BRIEF DESCRIPTION OF THE DRAWINGS

The present disclosure is illustrated by way of example and not limited in the accompanying figures:

FIG. 1 depicts a side perspective view of an illustrative embodiment of a cleaning implement;

FIG. 2 depicts a side perspective view of an illustrative embodiment of a cleaning implement;

FIG. 3 depicts a side view of an illustrative embodiment of a cleaning implement;

FIG. 4 depicts a top view of an illustrative embodiment of a cleaning implement;

FIGS. 5 and 6 depict side views of an illustrative embodiment of a cleaning implement;

FIG. 7 depicts views of a illustrative embodiment of coupling mechanism configured to receive a corresponding structure of a handle;

FIG. 8 depicts a bottom perspective view of an illustrative embodiment of a cleaning implement; and

FIG. 9 depicts a side perspective view of an illustrative embodiment of a cleaning implement.

### DETAILED DESCRIPTION

In the following description of the various examples and components of this disclosure, reference is made to the accompanying drawings, which form a part hereof, and in which are shown by way of illustration various example structures and environments in which aspects of this disclosure may be practiced. It is to be understood that other structures and environments may be utilized and that structural and functional modifications may be made from the specifically described structures and methods without departing from the scope of the present disclosure. Further, it is to be understood that the drawings may represent the scale of different components of one single embodiment; however, the disclosed embodiments are not limited to that particular scale.

Also, while the terms “upper,” “lower,” “top,” “bottom,” “front,” “back,” “rear,” “side,” “forward,” “rearward,” and “backward” and the like may be used in this specification to describe various example features and elements of certain embodiments, these terms are used herein as a matter of convenience, e.g., based on the example orientations shown in the figures and/or the orientations in typical use. Nothing in this specification should be construed as requiring a specific three dimensional or spatial orientation of structures in order to fall within the scope of this disclosure.

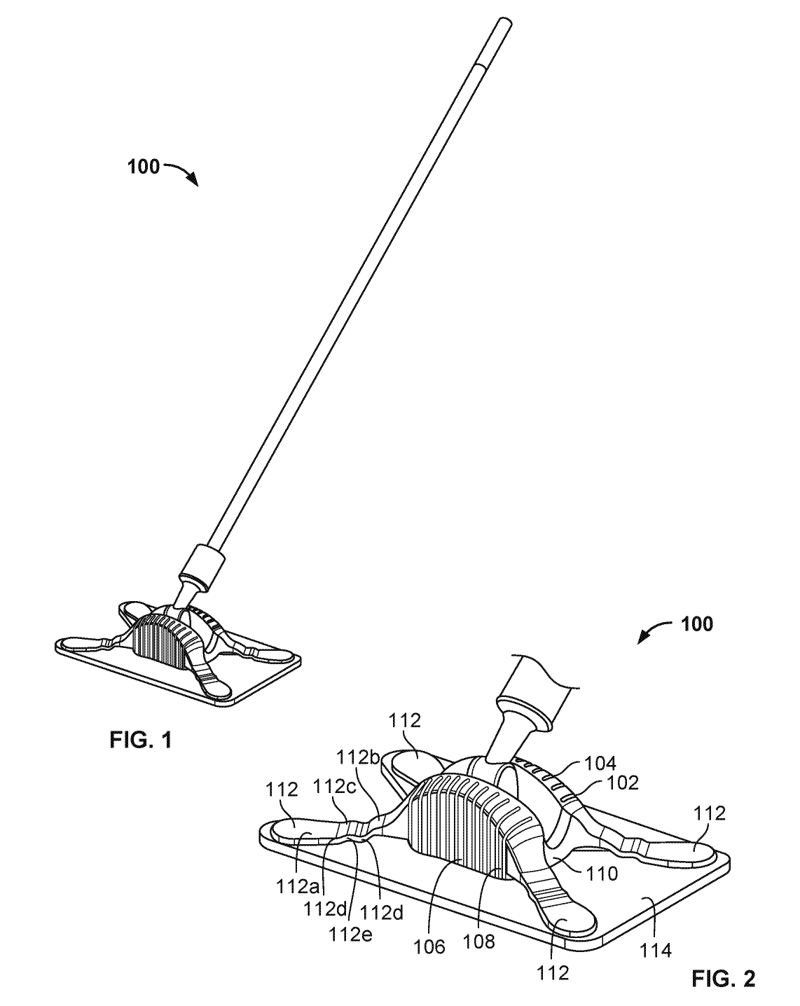

FIGS. 1 and 2 depict a side perspective view of an illustrative embodiment of a cleaning implement. In some embodiments, the cleaning implement 100 may be in the form of a bath scrubber. The cleaning implement 100 may include a base 102 comprising a top surface 104, a bottom surface 106, a first pair of side surfaces 108 (disposed on opposite sides of base 102 from one another), and a second pair of side surfaces 110 (disposed on opposite sides of base 102 from one another). The top surface 104 may be curved and, as a result, have multiple different heights (in relation to a surface when base 102 is disposed on the surface) at various portions of the top surface. The bottom surface 106 may have a different height when base 102 is disposed on a surface, which, in some embodiments, may correlate to a thickness of a cleaning pad 114.

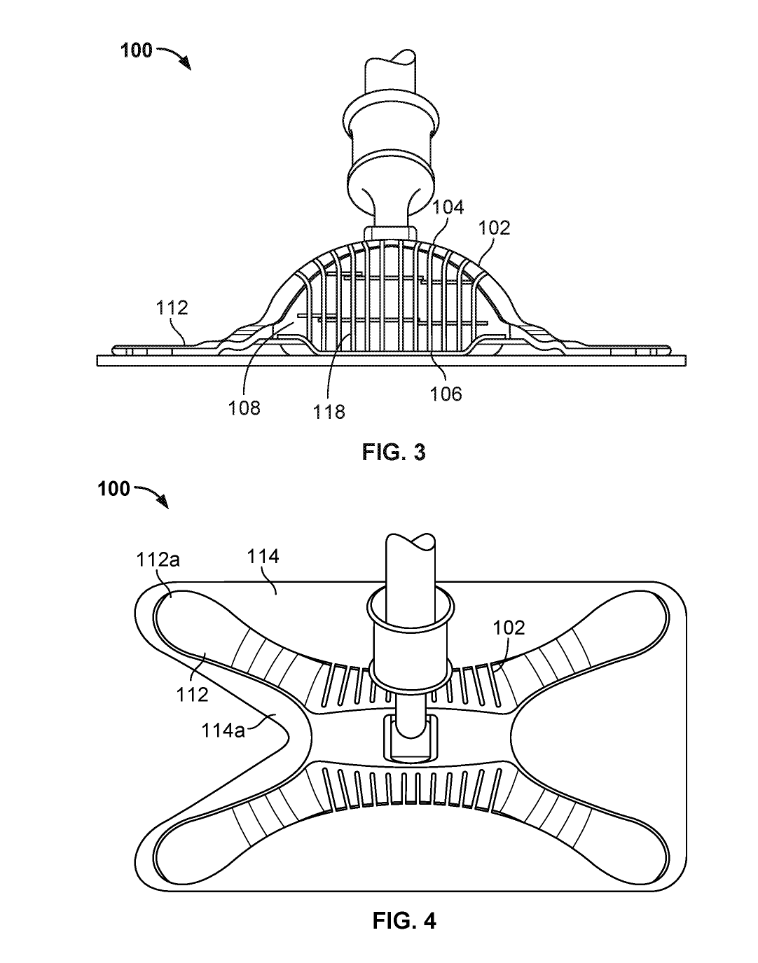

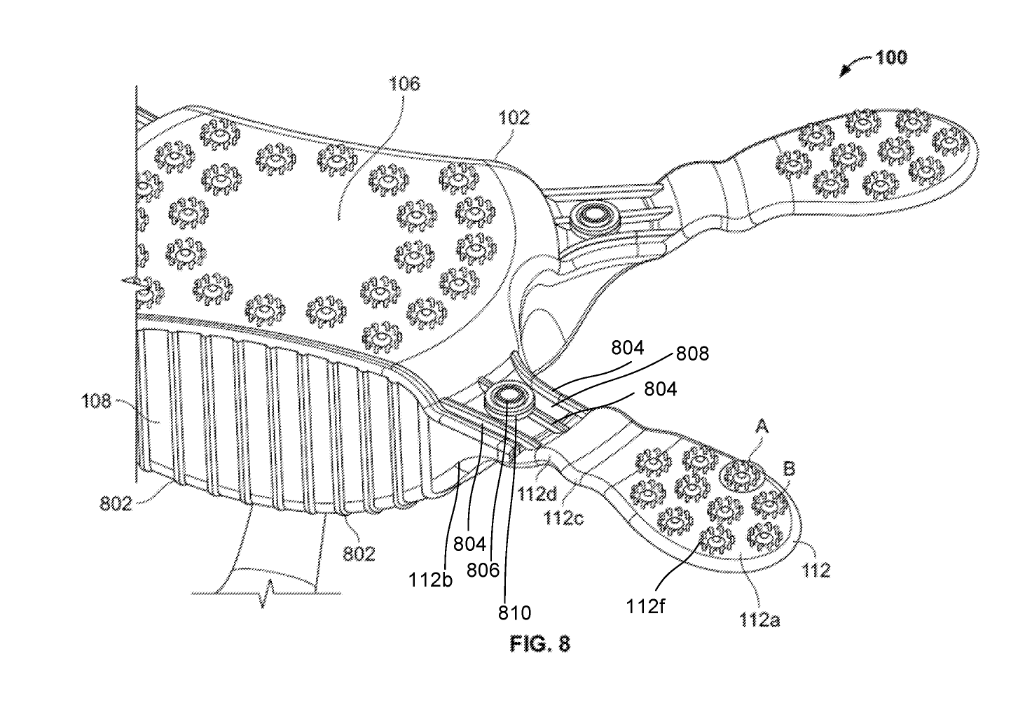

The base 102 may include multiple projections 112, which may be in the form of elongate tabs, elongate flanges, or the like, and extending (e.g., radially outward) from base 102. In some embodiments, projections 112 may extend out from side exterior surfaces 108, side exterior surfaces 110, and/or a combination of side exterior surfaces 108, 110 (e.g., a corner formed by a side exterior surface 108 and a side exterior surface 110). A bottom surface 112f (shown in FIG. 8) of a distal end portion 112a of each of the projections 112 may be configured to be removably coupled to cleaning pad 114. A height of the bottom surface 112f when base 102 is disposed on a surface may be substantially the same as the height of bottom surface 106, which may correlate to a thickness of cleaning pad 114. A proximate end portion 112b of projections 112 may have a height in between the height of bottom surface 106 and a lowest height of top surface 104. As illustrated in FIGS. 2 and 3, for example, in various embodiments, portions of the projections are not in contact with the pad because they are disposed at a height above the pad. In certain examples, only the terminating ends (e.g., the bottom surfaces 112f of the distal end portions 112a) of the projections 112 are typically in contact with the cleaning pad 114. In other examples, the bottom surface 106 of the base 102 and the bottom surfaces 112f of the distal end portions 112a of the projections 112 may each be in contact with and engage the cleaning pad 114. In one or more arrangements, projections 112 may extend from a center portion of one or more of the side surfaces 108, 112. In some embodiments, base 102 and projections 112 may be unitarily formed. In other embodiments, proximate end portion 112b may be coupled to base 102 and not unitarily formed.

In addition to each projection 112 having a distal end portion 112a and a proximate end portion 112b, each projection 112 may include an intermediate portion 112c disposed between a distal end portion 112a and a proximate end portion 112b. Each intermediate portion 112c may be resilient and, thus, the intermediate portions 112c may also be referred to herein as resilient sections 112c. In some examples, the adjacent portions at the ends of the projections (e.g. the portions connecting the projections to the base) are not resilient and/or flexible. In some examples, the base is not resilient and/or flexible. In certain examples, one or more of the other portions (e.g. 112a and 112b) are also resilient and/or flexible. In certain examples, one or more of these other portions are flexible while the intermediate portion is not. In certain examples, the projection, by virtue of its shape, is only vertically flexible, and does not, or essentially does not flex, in the horizontal direction.

The resilient sections 112c of the projections 112 may flex, bend and/or otherwise deflect such that distal end portion 112a may change height relative to a surface on which base 102 is disposed. For instance, in certain examples, the resilient section 112c of a projection 112 allows a distal end portion 112a to deflect from a first projection height (which may be equal to the first height of the base, or may be a different height) to at least a second projection height. In some instances, the second projection height may be greater than the first projection height (e.g., bending up). In other instances, the second projection height may be less than the first projection height (e.g., bending down). In both cases, the height of the proximate end portion may be maintained and/or otherwise remain constant by virtue of its attachment to base 102.

In various embodiments, the resilient portion 112c of each projection 112 may include an undulating surface. In some examples, the resilient portion 112c of each projection 112 may have a wave-like shape with one or more ripples and formed by at least one concave region and at least one convex region. As shown in the example of FIG. 2, the resilient portion 112c of each projection 112 comprises a pair of concave regions 112d separated by a convex region 112e. In various examples, the resilient portion 112c of each projection 112 comprises a flat surface connected to distal end portion 112a, a first concave surface connected to the flat surface, a first convex surface connected to the first concave surface, a second concave surface connected to the first convex surface, and a second convex surface connected to the second concave surface, the second convex surface connected to the exterior side surface (e.g., side surface 108, 110) of base 102.

In some examples, the resilient portion 112c comprises a plurality of curved, angled, or stepped sections, for example two or more of these sections, or three or more of these section. In some examples, the portion comprises one or more concave and/or convex sections, for example one of each, or two of one separated by the other (e.g. two concave sections separated by a convex, or vice versa). In some examples, one or more flat and/or non-resilient sections may be present between some or all of these features (e.g. a flat section between a concave and a convex section). In certain examples, the resilient portion 112c has a length equal to approximately 40% of the total length of the projection 112. In some examples, the resilient portion 112c has a length equal to approximately 35-45% of the total length of the projection 112, or approximately 30-50%, or approximately 20-60%. In certain examples, the resilient portion 112c has a length equal to approximately 45% or less of the total length of the projection 112, or 50% or less, 40% or less, or 35% or less. In various examples, the resilient portion 112c has a length equal to approximately 40% or more of the total length of the projection 112, or 30% or more, or 50% or more, or 60% or more.

In some examples, at least one, or each, feature of the resilient portion 112c (e.g. a concave region) has a length equal to approximately 15% of the total length of the projection 112, approximately 20%, approximately 15-20%, approximately 15-25%, or approximately 10-30%. In certain examples, at least one, or each, feature of the resilient portion 112c has a length equal to approximately 20% or less of the total length of the projection 112, or 15% or less, 25% or less, or 30% or less. In various examples, the resilient portion 112c has a length equal to approximately 10% or more of the total length of the projection 112, or 15% or more, or 20% or more, or 25% or more. In certain examples, one or more, or all, of the concave and/or convex sections have a curvature with a consistent radius. In some example, only a portion of the curved section has a curvature with a consistent radius (e.g. half of the curved section (or more), three-quarters (or more), or a third (or more)). In some examples, multiple concave and/or convex sections each have a curvature with the same consistent radius. In some examples, the curvature tapers towards an inflection point meeting another portion of the base and/or projection, for example another resilient feature such as an opposite curved surface (e.g. a convex to concave transition).

In some examples, the consistent curvature of a curved section has a radius of approximately 40% of the total length of the projection 112, approximately 30%, approximately 50%, approximately 30-50%, approximately 35-35, approximately 20-60%, or approximately 40-45%. In certain examples, examples, the consistent curvature of a curved section has a radius of approximately 40% or less of the total length of the projection 112, approximately 45% or less, approximately 50% or less, approximately 35% or less, or approximately 30% or less. In certain examples, examples, the consistent curvature of a curved section has a radius of approximately 40% or more of the total length of the projection 112, approximately 45% or more, approximately 30% or more, approximately 35% or more, or approximately 25% or more.

In various examples, one or more curved (e.g., concave) sections 112d or undulating sections resiliently flex when distal end portion 112a is deflected, for example when cleaning implement 100 is in contact with a curved surface to be cleaned (e.g., the interior perimeter of a bathtub's floor). In this representative example, a curved surface to be cleaned deflects the distal end portion 112a upward and the projection 112 thereby enabling a portion of cleaning 114 coupled to distal end portion 112a to be deflected upwards. Further, the resilient section 112c of each projection 112 may be biased in a configuration in which the height of the bottom surface of distal end portion 112a is substantially the same height (as shown in FIG. 2) or a set difference in height from the height of the bottom surface 106. By virtue of the upward deflection of distal end portion 112a and resilient flexing of resilient section 112c from its biased initial configuration to a flexed configuration, a resulting downward force is imposed by the resilient section 112c on distal end portion 112a and, thus, a portion of cleaning pad 114 coupled to or near the distal end portion 112a. As a result, this portion of the cleaning pad 114 is held firmly against the curved surface to be cleaned. In this and other examples, at the same time, the upward deflection does not cause other, inner portions of cleaning pad to lose contact with the surface being cleaned, as could happen with a rigid projection.

As an example, a user may wish to clean an interior perimeter of a bathtub's floor. The user may apply a force to a handle 116 coupled to base 102, which may transfer the force to base 102 and projections 112. As the user moves cleaning implement 100 along the floor of the bathtub, cleaning implement 100 may contact a curved surface and, as a result, cause a distal end portion 112a to be deflected upwards such that a portion of cleaning pad 114 couple to or near distal end portion 112a is in contact with a sidewall of the bathtub. At the same time, another portion of cleaning pad 114 near the bottom surface of base 102 may be in contact with a floor of the bathtub (which may be substantially perpendicular to its sidewall). Additionally, at the same time, yet another portion of the cleaning pad 114 that is near the resilient section 112c may be in contact with the curved surface of the bathtub in between the bathtub's sidewall and floor. Cleaning pad 114 may be held in contact with the bathtub's sidewall and curved surface by virtue of a downward force on the distal end portion 112a resulting from the resilient section 112c being deflected away from its biased configuration to a flexed configuration. As a result, the user may clean a portion of the bathtub's sidewall, floor, and a curved surface between its sidewall and floor at the same time. When the user removes the cleaning implement 100 from the curved surface, resilient section 112c may return to its biased configuration from the flexed configuration.

FIG. 3 depicts a side view of cleaning implement 100. As shown in FIG. 3, each of the pair of exterior side surfaces 108 may include one or more elongated apertures 118 or slits extending from top surface 104 to bottom surface 106. The apertures 118 may be configured to let water and/or other liquid flow there through. As a result, any water within base 102 may drain out of base 102 via apertures 118. In one or more alternative arrangements, each pair of exterior side surfaces 108 might not include the one or more elongated apertures 118. Instead, each pair of exterior side surfaces 108 may include one or more elongated ridges 802 (depicted in FIG. 8), which may extend above the corresponding exterior side surface 108. The one or more elongated ridges may provide additional rigidity to the base 102. In still other examples, any other number or shapes of ridges, ribs, cavities, apertures, or slots may be present. In certain embodiments, the side surface may be a continuous surface without any of these features. In certain examples, the implement comprises 8 or more apertures, ridges, cavities, and the like. In other examples, the implement comprises 10 or more, or 12 or more. In some examples, the side surface(s) may comprise features configured to allow a user to more easily grasp the implement (e.g. in examples where a user may disconnect the implement base from the handle), such as a textured surface, the ridges and/or slots mentioned above, overlay of a frictional material (e.g. rubber), projections, lips, or depression shaped and placed for insertion of a user's finger, or other grasping features.

FIG. 4 depicts a top view of cleaning implement 100. As shown in FIG. 4, the projections 112 may collectively form a substantially X-shape with each distal end 112a being coupled to cleaning pad 114 at or near a corner of an outer edge 114a of cleaning pad 114. Additionally, cleaning pad 114 may have at least one recessed sections that may be substantially V-shaped, and taper from a relatively wide base section, so that a portion of an outer edge 114a of cleaning pad 114 may be substantially proximate to base 102, but where the sections of the cleaning pad still have a substantial width extending beyond both sides of the adjacent projections 112, and spanning approximately half the width of the pad at the base of the section. In certain examples, some, most or all of the cleaning pad edges may trace a consistent perimeter around the base and lack any recessed sections (e.g. there are no recessed sections, or only a single recessed section such that a majority of the outer perimeter is consistent). By virtue of having a V-shaped portion of cleaning pad 114 and an X-shaped projections 112, these examples of the cleaning implement 100 may more easily clean areas on two opposite sides of an object at the same time. As an example, when an object (e.g., a faucet, shower head or drain) may be disposed in the V-shaped area, a first projection may be disposed on one side of the object while a second projection may be disposed on the opposite side of the object so that cleaning pad 114 may quickly and efficiently clean areas around the object. In some examples, the cleaning pad may be substantially circular, rectangular, or polygonal. In certain embodiments, the cleaning pad may have a cut or slit in between two projections (or more than one cut/slit), allowing a user to clean around an object by positioning it in the slit/cut of the cleaning pad, but otherwise the cut sections are touching or essentially touching each other. Additionally, as shown in FIG. 3, base 102 and projections 112 cover a minority of surface area of cleaning pad 114. In some embodiments, they may cover less than 50%, 40%, 35%, or 25%, of cleaning pad 114. In yet other embodiments, they may cover even less. In certain examples, substantially the entire perimeter of the cleaning pad, with the exception of four or fewer points spaced along the perimeter, is uncovered. In some embodiments, only vertices of the cleaning perimeter are covered.

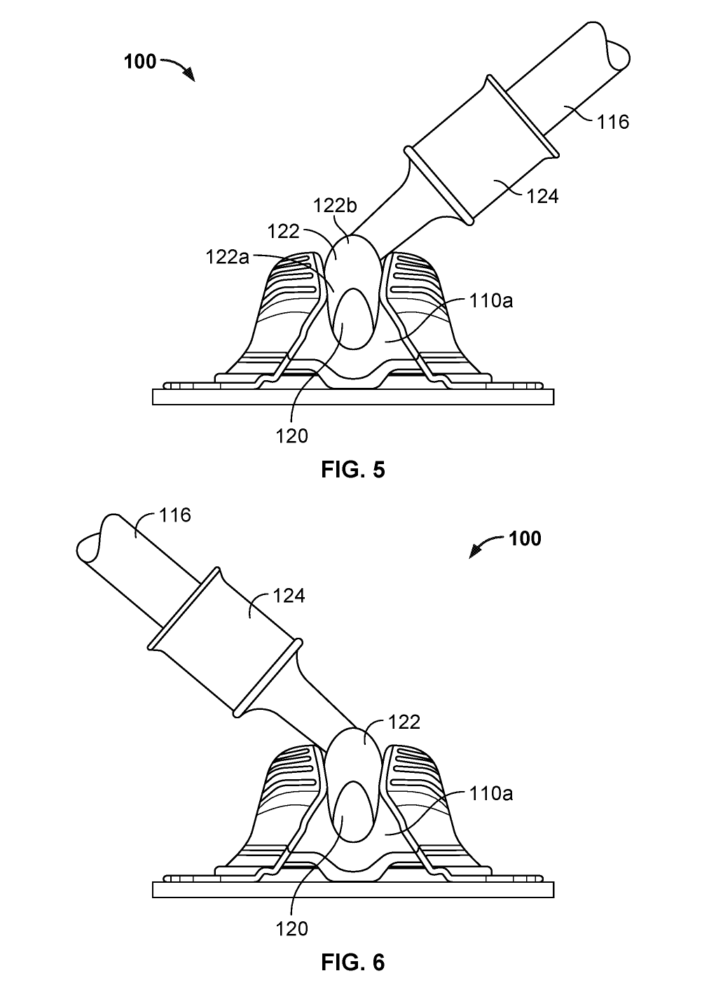

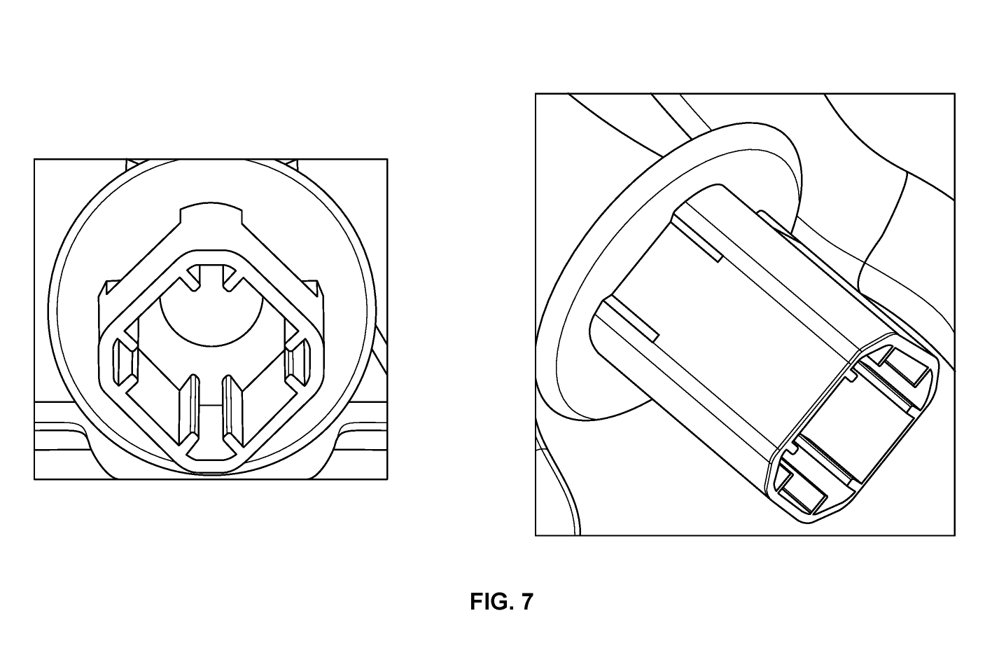

FIGS. 5 and 6 depict various side views of cleaning implement 100. Base 102 may define a hollow U-shaped channel 120 that is exposed on one side (e.g., an open-faced channel or recess). Channel 120 may extend from one exterior side surface 110a (shown in FIG. 5) to the other exterior side surface (not shown) on the opposite side of base 102. Channel 120 may be exposed so that a connection component 122 may be disposed within channel 120. The channel may have a varying width (as illustrated in the example of FIG. 4) where the channel tapers to its widest width at the middle. In some examples, the width of the channel at its narrowest dimension (e.g. at the side edges of the channel) is greater than the width of the top of each side of the base at their narrowest width (e.g. in the middle of each side section of base 102, as illustrated in the example of FIG. 4, where these sections are relatively narrow due to the relatively larger width of the channel). In other examples, a recess or hole contains a connection component. Connection component 122 may include a lower portion 122a that is pivotally coupled to base 102, and an upper portion 122b that is pivotally coupled to handle 116 (via cylindrical housing 124). The handle 116 and cylindrical housing 124 may pivot about a first axis, which in at least one instance (e.g., moment in time) may be parallel to an axis defined by channel 120. The connection component 122 may pivot about a second axis with respect to base 102, which, in at least one instance (e.g., moment in time), may be perpendicular to the first axis. In some example, the side surfaces of the channel prevent pivoting beyond a certain rotational degree. In certain examples, the connection component 122 (or another component) is configured to allow a user to selectively disconnect the base from the handle, and clean while holding the base directly in their hand. For example, the tapered section connection the cylindrical housing 124 to the connection component 122 may be selectively removed from the connection component.

Connection component 122 may be coupled to handle 116 via cylindrical housing 124. Cylindrical housing 124 may be coupled to handle 116 via a threaded engagement or another coupling mechanism, such as corresponding tabs and recesses, or one or more fasteners. Cylindrical housing 124 may be pivotally coupled to connection component 122 as discussed above. FIG. 7 shows views of an example embodiment of a coupling mechanism configured to receive a corresponding structure of a handle.

FIG. 8 depicts a bottom perspective view of an illustrative embodiment of a cleaning implement 100. As discussed above, each pair of exterior side surfaces 108 may include one or more elongated ridges 802 (depicted in FIG. 8), which may extend above the corresponding exterior side surface 108. The one or more elongated ridges may provide additional rigidity to base 102.

Each of the bottom surface 106 of the base 102 and the bottom surface 112f of the distal end portion 112a of each projection 112 may include multiple sets of hooks A extending from their respective bottom surface (e.g., bottom surface 106 or bottom surface 112f) and configured to engage and retain the cleaning pad 114 (not shown). Each set of hooks A may form a circular pattern (e.g., a circle). In addition, a tip end of each hook within each set of hooks A may point along a same circular direction. As shown in FIG. 8, each hook of each set of hooks A may point in a counter-clockwise direction (or, alternatively, in a clock-wise direction). The circular pattern for each set of hooks A permit easier positioning and realization of the cleaning implement 100 over complex shapes.

Each of the bottom surface 106 of the base 102 and the bottom surface 112f of the distal end portion 112a of each projection 112 may include multiple projections B (e.g., conical, cylindrical, or frusto-conical bumps) that extend away from their respective bottom surface (e.g., bottom surface 106 or bottom surface 112). In some examples, the bottom surface of the cleaning apparatus (e.g. surfaces 106 and 112f, and therefore including all of the projections 112) are made from one continuous piece of material (e.g. molded material). In some examples, the continuous bottom surface is only attached via one or more cylindrical protrusions (e.g. protrusions 806 as described below) or other discrete connections to the upper portions of the base. In various embodiments, this allows the interior portion of bottom surface 106 to move inward relative to the side surfaces of the base, to further facilitate vertical flexing of the projections (as there are no connections generally along the intersection of the bottom and side surfaces). There may be a single projection B for each set of hooks A, and may be positioned at a center of the circle defined by the set of hooks A. The projections B may be sized similar to a hook and may be configured to prevent a hook from its corresponding set of hooks A from being deformed (e.g., crushed) as a result of pressure applied to the hook via the cleaning pad 114 when the cleaning pad 114 is cleaning hard surfaces. In some examples, the hooks or other connection features are configured to connect with various types of cleaning pads, such that a user may change the type of cleaning pad depending on the surface to be cleaned.

In one or more arrangements, a proximate end portion 112b of a projection 112 may be configured to flex with respect to the base 102 or other sections (e.g., sections 112a,c) of the projection 112. For instance, a bottom side of each proximate end portion 112b of the projections 112 may include one or more bottom surfaces 808 configured to flex relative to the base. In some examples, the surfaces 808 of the proximate end potion comprise one or more flexible and elongate ridges 804. As shown in FIG. 8, a bottom side of each proximate end portion 112b may include three (3) flexible and elongate ridges 804 at various point along the width of the bottom surface 808, which permit the proximate end portion 112b of the projections 112 to vertically flex and/or otherwise vertically bend. The flexible and elongate ridges 804 may be biased in a particular configuration such that they return to their biased configuration after a force causing them to flex has been removed. In some cases, in addition to the surface 808 and/or ridges 804 of the proximate end portion 112b being flexible (and/or other portions of the proximate end portion), the sections 112a and/or 112c of the projections 112 may also be flexible. In other cases, while the ridges 804, bottom surface 808 and/or other portions of the proximate end portion 112b may be flexible, sections 112a and/or 112c of the projections 112 may be rigid and/or otherwise not flexible. In certain examples, the ridges, when elongated across surface 808, prevent or substantially prevent horizontal bending of the projection. In various examples, the proximate end further comprises an outer lip 914 configured to block any outward, horizontal flexing of the projection, or other feature(s) blocking such relative flexing (e.g. a flange, one or more projections, and the like). In various embodiments, the proximate end comprises an inner lip and/or another feature to block inward horizontal flexing.

In order to prevent a proximate end portion 112b from over-flexing in a bottomward direction thereby causing it to deform, the bottom side of the proximate end portion 112b of the projection 112 may additionally include a cylindrical protrusion 806. The cylindrical protrusion may be directly or indirectly connected to top surface 104 or another, non-projection part of the cleaning apparatus. In some examples, the protrusion may extend down form the interior of top surface 104 until it meets the appropriate proximate end potion. The cylindrical protrusion 806 may be configured to prevent the proximate end portions 112b of the projections 112 from flexing beyond a predetermined angle. For instance, upon a proximate end portion 112b reaching the predetermined angle, the cylindrical protrusion 806, may abut and/or otherwise contact one or more areas of the proximate portion 112b, or base 102 (e.g. part of bottom surface 106), or another section (e.g., section 112c) of the projection 112 to prevent the proximate end portion 112b and/or surface 808 from flexing beyond the predetermined angle (although in some examples, the remaining portions of the projection, e.g. 112a-f, may still flex further). In some cases, the cylindrical protrusion 806 may contact one or more ridges 804, or a surface connected to one of more of the ridges, such as a circular ring 810, a cylindrical cavity (or aperture) in the proximate portion material (e.g. a cavity defined by such a ring), or both. In some examples, other shapes and or features may be used that act to prevent further flexing of the projection by contact with a feature connected to (or a part of) another portion of the cleaning apparatus such as base 102. In some cases, a diameter of the cylindrical protrusion 806 may be equal to 50% of the width of the proximate end portion 112b.

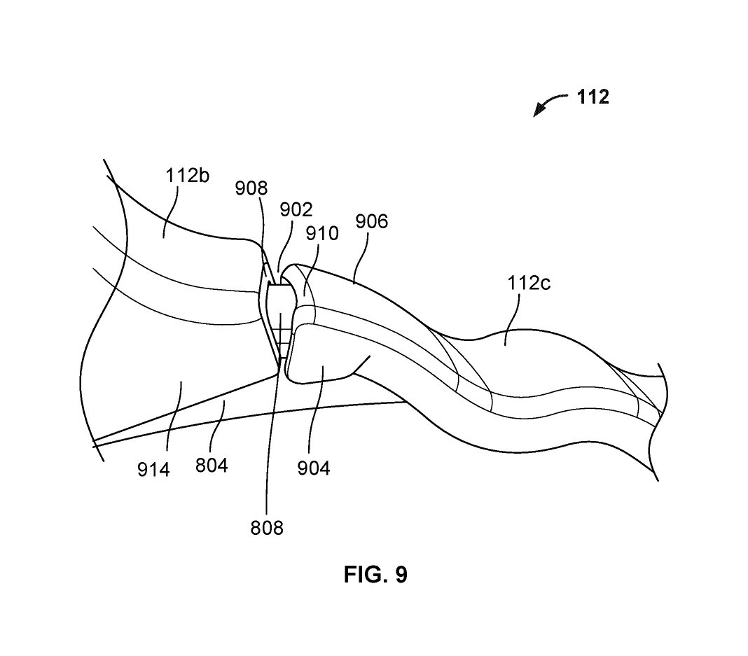

FIG. 9 depicts a side perspective view of an illustrative embodiment of a cleaning implement 100. In FIG. 9, the proximate end portion 112b of a projection 112 is shown in a flexed configuration. An upper portion of the proximate end portion 112b of the projection 112 may define an elongate recess 902 (e.g., an open faced U or V-shaped channel) extending from a first side 904 of the proximate end portion 112b to a second side 906 of the proximate end portion 112b. The upper portion may include two opposing side surfaces 908 and 910 that define the elongate recess 902.

As discussed above, the proximate end portion 112b of the projection 112 is configured to flex. In this example, the bottom surface 808 of the proximate end portion is configured to flex, while an upper piece generally enclosing the bottom surface is not. In some cases, as the proximate end portion 112b flexes in a bottomward direction, the surfaces 908 and 910 may move farther apart from one another thereby enlarging a width of the elongate recess 902. As discussed above, the cylindrical protrusion 806 may prevent the proximate end portion 112b from over flexing in the downward direction. In other cases, as the proximate end portion 112b flexes in a upward direction (opposite the downward direction), the surfaces 908 and 910 may abut and/or otherwise contact one another to prevent the proximate end portion 112b from flexing beyond a different predetermined angle (and, in some examples, the cylindrical protrusion may also act to limit upward flexing). In yet other cases, the proximate end portion's 112b flexibility may be limited in a side-to-side direction as a result of the flexible and elongate ridges 804 of the proximate end portion 112 being in a substantially parallel configuration as illustrated in FIG. 8.

While some of the examples described herein are in relation to a bathtub, cleaning implement 100 may be used to clean a number of other objects such as toilet in a similar manner. Additionally, while some of the objects include a curved surface which may cause an upward deflection of the distal end portion 112a, the distal end portion 112a may also deflect upward even if the object(s) to be cleaned do not have a curved portion but rather a sharp corner or other features altering the height of the surface to be cleaned, or the relative orientations thereof. As an example, the cleaning apparatus 100 may be used clean a hardwood floor and a base board of a wall at the same time. In such an example, the user may place cleaning implement 100 against the base board such that the distal end portion 112a deflects upward.

Each of the components (e.g., base 102, projections 112, cylindrical housing 124, etc.) may be composed of the same or different materials including various types of plastics or other materials. Cleaning pad 114 may be any composed of any material known in the art for cleaning pads, and in certain examples may be a scrubber sponge, or a microfiber material.

Cleaning implement 100 may efficiently and quickly clean curved surfaces. By virtue of resilient sections 112c and/or other resilient sections of the projections, projections 112 may deflect upward and maintain pressure on cleaning pad 114 so that it remains in contact with the curved surface. Additionally, by virtue of the V-shaped portion of the cleaning pad (in examples including such a feature) and the X-shaped projections, the cleaning pad 114 may clean opposite sides of an object such as a drain at the same time.

In some embodiments, the cleaning implement or components thereof are made from, consist, or comprise plastic or metal. In some of these embodiments, the material is made from polyethylene terephthalate, polyethylene, high-density polyethylene, poly-propylene or polystyrene.

Aspects of this disclosure have been described in terms of illustrative embodiments thereof. Numerous other embodiments, modifications and variations within the scope and spirit of the disclosure will occur to persons of ordinary skill in the art from a review of this entire disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A cleaning apparatus comprising:
a base comprising a plurality of projections radially extending outward from an outer surface of the base,
wherein each of the projections is configured to be coupled with a cleaning pad, and
wherein at least one projection of the plurality of projections includes a flexible resilient portion configured to deflect in response to contact of the cleaning apparatus with a curved surface.

2. The cleaning apparatus of claim 1, further comprising:
the cleaning pad coupled to each of the projections,
wherein the at least one projection is configured to generate a force in response to a deflection of the at least one projection to maintain contact between the curved surface and the cleaning pad.

3. The cleaning apparatus of claim 1, wherein the flexible resilient portion of the at least one projection comprises at least one concave region and at least one convex region.

4. The cleaning apparatus of claim 3, further comprising:
the cleaning pad coupled to each of the plurality of projections,
wherein a portion of an outer edge of the cleaning pad is disposed substantially proximate to the base.

5. The cleaning apparatus of claim 4,
wherein each projection of the plurality of projections includes a distal end portion and a proximate end portion opposite the distal end portion,
wherein each proximate end portion is coupled to the base, and
wherein each distal end portion is coupled to the cleaning pad near the outer edge of the cleaning pad.

6. The cleaning apparatus of claim 1,
wherein the base comprises a first plurality of sets of hooks extending from a bottom surface of the base, wherein each set of hooks of the first plurality of sets of hooks forms a different circle;
wherein the base comprises a first plurality of conical projections extending from the bottom surface of the base, wherein each conical projection is positioned at a center of different circles formed by the first plurality of sets of hooks;
wherein a first projection of the plurality of projections comprises a second plurality of sets of hooks extending from a bottom surface of a first projection, wherein each set of hooks of the second plurality of sets of hooks forms a different circle;
wherein the first projection comprises a second plurality of conical projections extending from the bottom surface of the first projection, wherein each conical projection is positioned at a center of different circles formed by the second plurality of sets of hooks.

7. The cleaning apparatus of claim 1, wherein the base defines an open-faced channel extending from a first side surface of the base to a second side surface of the base opposite the first side surface, the cleaning apparatus further comprising:
a connection component pivotally coupled to the base and disposed within the open-faced channel.

8. The cleaning apparatus of claim 7, further comprising:
a cylindrical housing pivotally coupled to the connection component, wherein the cylindrical housing is configured to pivot about an axis that is at least in one instance parallel to an axis defined by the open-faced channel.

9. The cleaning apparatus of claim 8, wherein the connection component is configured to pivot about an axis that is in at least one instance substantially perpendicular to the axis defined by the open-faced channel.

10. A kit comprising:
a cleaning pad; and
a base comprising a plurality of projections that collectively form a substantially X-shape,
wherein each projection comprises an undulation portion configured to move between a biased configuration and a flexed configuration,
wherein each projection comprises a distal end portion and proximate end portion opposite the distal end portion,
wherein each of the proximate end portions is coupled to the base, and
wherein each of the distal end portions is configured to be coupled to the cleaning pad near a respective corner of the cleaning pad.

11. The kit of claim 10, further comprising
a connection component pivotally coupled to the base and disposed within an open-faced channel defined by the base.

12. The kit of claim 11, further comprising:
a cylindrical housing pivotally coupled to the connection component, wherein the cylindrical housing is configured to be coupled to a handle via a threaded engagement.

13. The kit of claim 10, further comprising:
wherein a projection, of the plurality of projections, is configured to move from the biased configuration to the flexed configuration in response to contact with a curved surface, and
wherein the projection is configured to move from the flexed configuration to the biased configuration in response to removal of contact from the curved surface.

14. The kit of claim 10, wherein the cleaning pad defines a recessed section that is substantially V-shaped.

15. A cleaning apparatus comprising:
a base comprising a plurality of projections, wherein each projection comprises a flexible portion that is biased in an initial configuration, wherein the base defines an open-faced channel extending from a first side surface of the base to a second side surface of the base opposite the first side surface; and
a connection component pivotally coupled to the base and disposed with the open-faced channel.

16. The cleaning apparatus of claim 15, further comprising a cylindrical housing pivotally coupled to the connection component, wherein the cylindrical housing is configured to pivot about a first axis and the connection component is configured to pivot about a second axis different from the first axis.

17. The cleaning apparatus of claim 15, wherein each projection comprises a plurality of concave regions and a plurality of convex regions to form a wave-like shape.

18. The cleaning apparatus of claim 15, further comprising:
a cleaning pad coupled to the plurality of projections,
wherein a projection, of the plurality of projections, is configured to deflect to a flexed configuration different from the initial configuration in response to contact by the cleaning pad with a curved surface.

19. The cleaning apparatus of claim 18, wherein the projection causes a force on the cleaning pad to maintain contact with the curved surface in response to deflecting to the flexed configuration.

20. The cleaning apparatus of claim 15, wherein the plurality of projections collectively from a substantially X-shape.
